(19) United States
(12) Patent Application Publication
(10) Pub. No.: US 2009/0168820 A1
(43) Pub. Date: Jul. 2, 2009

(54) Mitigated Temperature Gradient-Distributed Bragg Reflector

(76) Inventors: Martin Achtenhagen, Plano, TX (US); Nuditha Vibhavie Amarasinghe, Richardson, TX (US)

Correspondence Address: SLATER & MATSIL, L.L.P., 17950 PRESTON RD, SUITE 1000, DALLAS, TX, 75252-5793, US

(21) Appl. No.: 11/966,908

(22) Filed: Dec. 28, 2007

(51) Int. Cl. H01S 3/042

(52) U.S. Cl. 372/34

(57) ABSTRACT

A semiconductor laser system comprising a gain region, a gain contact coupled to the gain region, and a distributed Bragg reflector (DBR) having a near side and a far side with respect to the gain region are provided. The DBR reflects a resonant frequency of light back into the gain region. The semiconductor laser system further comprises a heat conducting structure, wherein the heat-conducting structure is positioned to transfer heat in a direction from the near side to the far side of the DBR grating, and an outcoupler, positioned to outcouple the resonant frequency of light from the semiconductor laser system.

### TECHNICAL FIELD

The present invention relates generally to semiconductor lasers, and more particularly to a system, structure, and method for increasing power output from a semiconductor laser with a distributed Bragg reflector.

### BACKGROUND

A laser is an optical source that emits photons in a coherent beam. Laser light is typically a single wavelength or color, and emitted in a narrow beam. Laser action is explained by the theories of quantum mechanics and thermodynamics. Many materials have been found that include the required characteristics for forming the laser gain medium needed to power a laser, leading to the invention of many types of lasers with different characteristics suitable for different applications.

A semiconductor laser is a laser in which the active medium is a semiconductor. A common type of semiconductor laser is formed from a p-n junction, a region where p-type and n-type semiconductors meet, and is powered by injected electrical current. As in other lasers, the gain region of the semiconductor laser is surrounded by an optical cavity. An optical cavity is an arrangement of mirrors, or reflectors, that form, for example, a standing wave cavity resonator for light waves. Optical cavities surround the gain region and provide feedback of the laser light. In a simple form of semiconductor laser, for example a laser diode, an optical waveguide may be formed in epitaxial layers, such that the light is confined to a relatively narrow area perpendicular (and parallel) to the direction of light propagation.

### SUMMARY OF THE INVENTION

In accordance with an illustrative embodiment of the present invention, a semiconductor laser system comprising a gain region, a gain contact coupled to the gain region, and a distributed Bragg reflector having a near side and a far side with respect to the gain region. The distributed Bragg reflector reflects a resonant frequency of light back into the gain region. The semiconductor laser system further comprises a heat-conducting structure, wherein the heat-conducting structure is positioned to transfer heat in a direction from the near side to the far side of the distributed Bragg reflector, and an outcoupler, positioned to outcouple the resonant frequency of light from the semiconductor laser system.

Advantages of preferred embodiments of the present invention include producing higher power output laser light. Many unwanted spectral features and the reduction in peak wavelength output of a standard laser system may be corrected in the illustrative embodiments. Because of this configuration, larger injected currents may be employed to produce an increased power output of the semiconductor laser while producing a stable spectrum output.

The foregoing has outlined rather broadly the features and technical advantages of an illustrative embodiment in order that the detailed description of the invention that follows may be better understood. Additional features and advantages of an illustrative embodiment will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the illustrative embodiments as set forth in the appended claims.

### BRIEF DESCRIPTION OF THE DRAWINGS

For a more complete understanding of the illustrative embodiments, and the advantages thereof, reference is now made to the following descriptions taken in conjunction with the accompanying drawings, in which:

FIG. 1 shows a top view of a portion of a semiconductor laser with a mitigated temperature gradient (MTG)-distributed Bragg reflector (DBR);

FIG. 2 depicts a lengthwise cross-sectional view of the grating-outcoupled, surface-emitting, semiconductor laser of FIG. 1;

FIG. 3 shows a closer view of an interface between a gain region and a distributed Bragg reflector (DBR) region;

FIG. 4 shows a detailed view of a prior art interface between a gain region and a DBR region without the heat conducting features of the illustrative embodiments;

FIG. 5 is a graph indicating the temperature gradient of the DBR (ΔT_{DBR}) for the injected currents I₁, I₂, and I₃;

FIG. 6a shows a plan view of a mitigated temperature gradient-distributed Bragg reflector (MTG-DBR), in accordance with an illustrative embodiment;

FIG. 6b shows a plan view of another MTG-DBR, in accordance with an illustrative embodiment;

FIG. 6c shows a plan view of yet another MTG-DBR, in accordance with an illustrative embodiment;

FIG. 6d shows a cross-sectional view of a MTG-DBR structure;

FIG. 7a shows three spectral curves simulated to show a baseline of a spectrum;

FIG. 7b shows a spectrum of an output of a semiconductor laser with an injected current of I₂; and

FIG. 7c shows a spectrum of an output of a semiconductor laser with an injected current of I₃.

Corresponding numerals and symbols in the different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that an illustrative embodiment provides many applicable inventive concepts that can be embodied in a wide variety of specific contexts. The specific embodiments discussed are merely illustrative of specific ways to make and use the invention, and do not limit the scope of the invention.

The present invention will be described with respect to illustrative embodiments in a specific context, namely a grating-outcoupled surface-emitting (GSE) laser. Illustrated embodiments show a semiconductor device having one or two distributed Bragg reflectors. The invention may also be applied, however, to many types of semiconductor laser systems comprising two or more distributed Bragg reflectors. Further, many laser system configurations are within the scope of the invention; for example, the outcoupler region may be located centrally on the laser device between two active gain regions, and the like. The term light, as used herein, refers to electro magnetic radiation of any wavelength whether visible or not.

A laser is composed of an active laser medium, or gain medium, and a resonant optical cavity. The gain medium transfers external energy into the laser beam. The area of the laser in which this transfer occurs is called the gain region. It is a material of controlled purity, size, concentration, and shape, which amplifies the beam by the quantum mechanical process of stimulated emission. The gain region is pumped, or energized, by an external energy source. Examples of pump sources include electricity and light. While the examples herein are of pump sources with electricity, light sources are within the scope of an illustrative embodiment. The pump energy is absorbed by the laser medium, placing some of its particles into excited quantum states. When the number of particles in one excited state exceeds the number of particles in some lower-energy state, population inversion is achieved. In this condition, an optical beam passing through the gain region produces more stimulated emission than the stimulated absorption, so the beam is amplified. The light generated by stimulated emission is very similar to the input light in terms of wavelength, phase, and polarization. This gives laser light its characteristic coherence, and allows it to maintain the uniform polarization and wavelength established by the optical cavity design.

The optical cavity contains a coherent beam of light between reflective surfaces so that photons may pass through the gain region more than once before it is emitted from the output aperture or lost to diffraction or absorption. One example of a reflective surface is a distributed Bragg reflector. As light circulates through the cavity, passing through the gain region, if the amplification or gain in the medium is stronger than the resonator losses, the power of the circulating light may rise exponentially. The gain region will amplify any photons passing through it, regardless of direction, but only the photons aligned with the cavity manage to pass more than once through the medium and so have significant amplification.

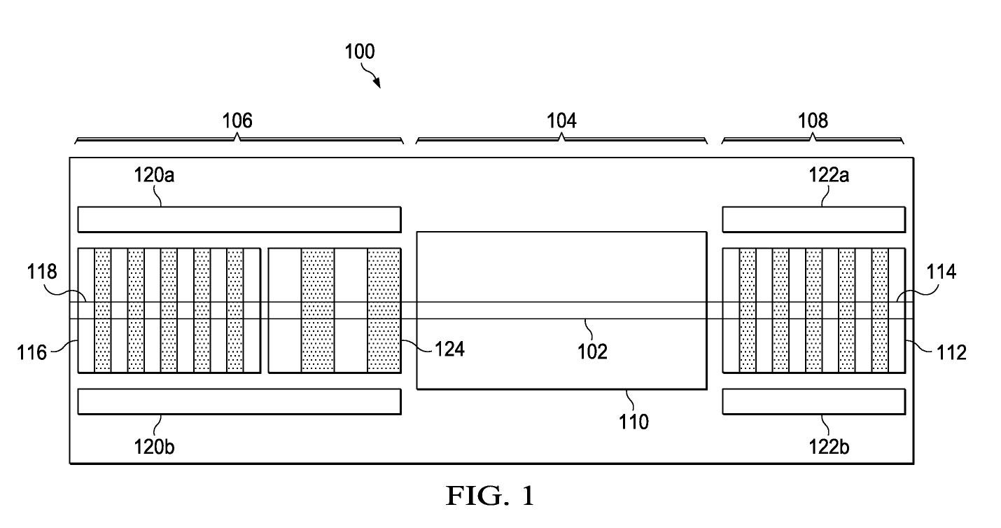

FIG. 1 shows a top view of a portion of a semiconductor laser with a mitigated temperature gradient (MTG)-distributed Bragg reflector (DBR). Improved semiconductor laser 100 is shown with gain region 104, MTG-DBR/outcoupler region 106, and MTG-DBR region 108. Gain region 104 includes waveguide ridge 102 extending the length of gain region 104. Gain region 104 has gain contact 110 covering waveguide ridge 102. Distributed Bragg reflector (DBR) gratings 112 and 116 are shown on both ends of semiconductor laser 100.

A distributed Bragg reflector (DBR) is a structure formed from multiple layers of alternating materials with a varying refractive index, or by periodic variation of some characteristic, such as height of a material, resulting in periodic variation in the effective refractive index in the material. Each boundary of variation causes a partial reflection of an optical wave. When the many reflections combine by constructive interference, high reflectivity over a narrow wavelength range is achieved. DBRs are passive structures that may be positioned at either end, or both ends of, and/or separate from, waveguide ridge 102 in the gain region. Waveguide ridge 102 is a structure that aids in containing the light in the improved semiconductor laser 100.

Outcoupler 124 is shown adjacent to gain region 104. An outcoupler outcouples the laser light from the laser system. Grating lines in DBR gratings 112 and 116, as well as outcoupler 124, are indicative of the periodic variation of the index of refraction within distributed Bragg reflector gratings 112 and 116 and outcoupler 124. Continuous waveguide ridges 118 and 114 are included in MTG-DBR/outcoupler region 106 and MTG-DBR region 108. Improved semiconductor laser 100 is shown as an example of a semiconductor laser with a continuous waveguide such as described in U.S. patent application Ser. No. 11/686,082, filed Mar. 14, 2007, which is hereby incorporated herein by reference. However, all semiconductor lasers employing DBR structures are within the scope of the invention. Heat conducting features 120a and 120b are positioned parallel to DBR grating 116, in accordance with an illustrative embodiment, and optionally parallel to outcoupler 124 as shown. Heat conducting features 122a and 122b are positioned parallel to DBR grating 112.

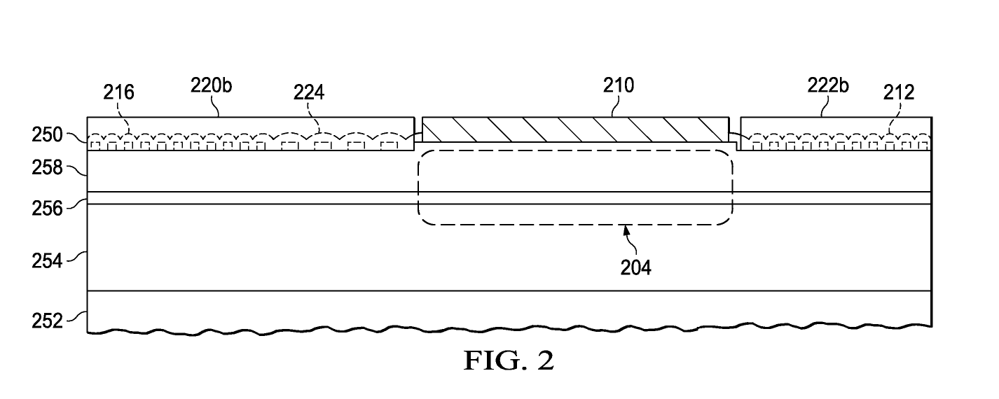

FIG. 2 depicts a lengthwise cross-sectional view of an improved semiconductor laser. Improved semiconductor laser depicts a cross-sectional view of improved laser 100 of FIG. 1. Gain contact 210 is shown over gain region 204. Note that gain region 204 is a relatively thin region near the surface of improved semiconductor laser.

Improved semiconductor laser may, for example, be formed on gallium arsenide (GaAs) substrate 252. Epitaxial layers consisting of aluminum gallium arsenide (AlGaAs) 254, indium gallium arsenide (InGaAs) 256, another layer of aluminum gallium arsenide (AlGaAs) 258, and gallium arsenide (GaAs) 250 are formed on gallium arsenide (GaAs) substrate 252.

The relatively thin layer of InGaAs 256 is termed the quantum well 256. A quantum well is a potential well that confines carriers, which were originally free to move in three dimensions, to two dimensions, forcing them to occupy a planar region. The effects of quantum confinement take place when the quantum well thickness becomes comparable at the de Broglie wavelength of the carriers, generally electrons and holes. The quantum well may be grown by molecular beam epitaxy or vapor deposition by controlling the layer thickness down to monolayers. DBRs 216 and 212, and outcoupler 224 are shown in phantom with heat conducting features 220b and 222b shown in the foreground.

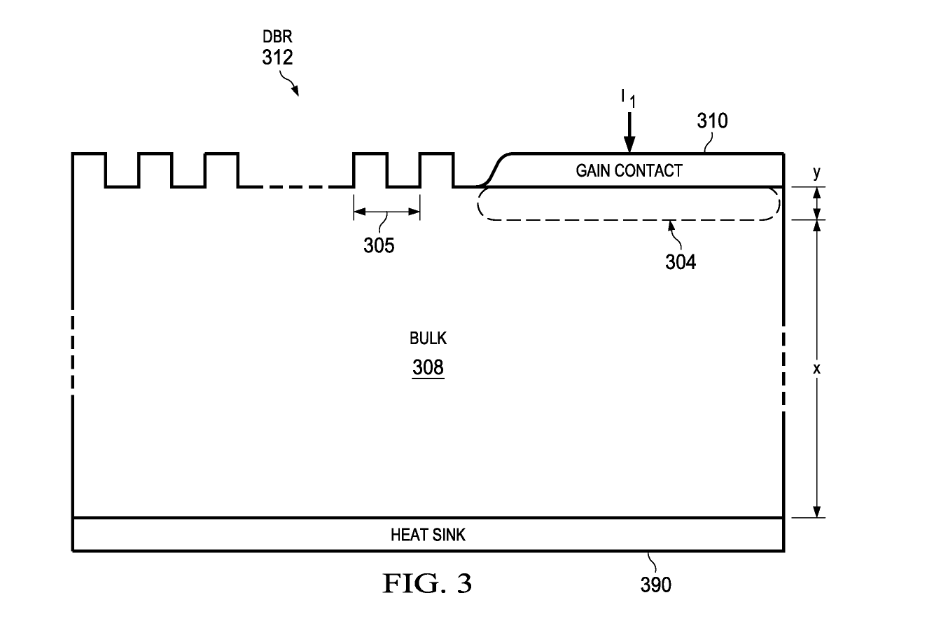

FIG. 3 shows a closer view of an interface between a gain region and a DBR region. Gain contact 310 is shown over gain region 304. Gain contact 310 provides a path for an injected current I to gain region 304. DBR grating 312 has periodic changes of the index of refraction. Period 305 may be on the order of a ¼ wavelength of the light to be reflected. Bulk region 308 has a much greater thickness than the quantum well (not shown) in gain region 304. Bulk thickness x may be on the order of 100 μm to 150 μm, while gain region thickness y may be on the order of several microns. Heat sink 390 is also the n-contact for the injected current I.

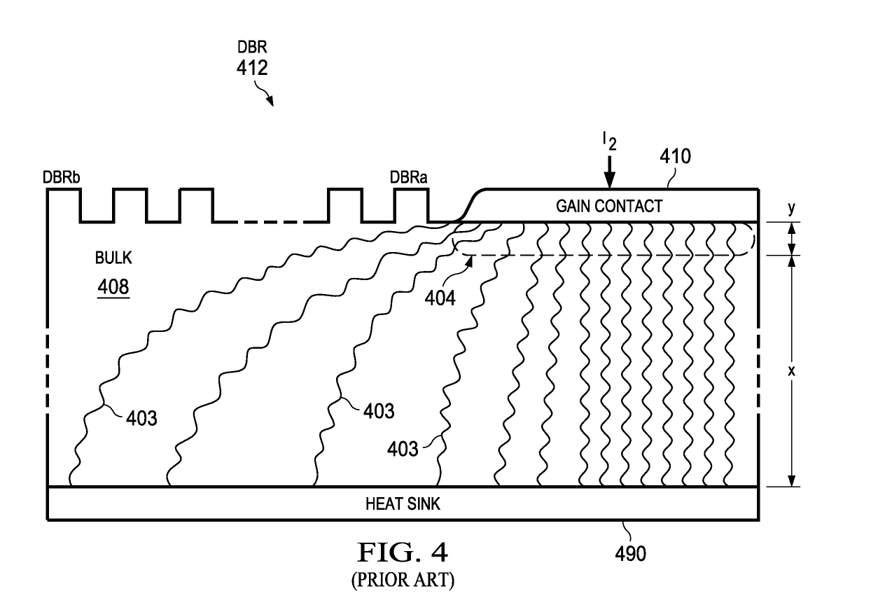

FIG. 4 shows a detailed view of a prior art interface between a gain region and a DBR region without the heat conducting features of the illustrative embodiments. A current I₂ is injected into the gain contact 410. As current I₂ is injected into gain region 404, through gain contact 410, photons are generated. However, some of the injected current I₂ does not generate photons. Instead, the unconverted energy of injected current I₂ causes the temperature of bulk 408 to rise, because of the dissipated power. The dissipated power may be calculated as the total power minus the optical power, P_{diss}=Pₜₒₜ−Pₒₚₜ. The total power is Pₜₒₜ=(Vf+Rs*I)*I, where V_{f} is forward voltage across the laser diode (for example, V_{f}=1.25V), Rs is the series resistance through bulk 408 (for example, ˜1.5 V/A) and I is the injected current. The optical power is Pₒₚₜ=η*(I−Iₜₕ), where T is the slope efficiency (for example, η=0.7 W/A) and Iₜₕ is the threshold current (for example, Iₜₕ=25 mA). The dissipated power generates a temperature increase in bulk 408 depending on the thermal resistance between the quantum well (not shown) and the heat sink 490 (a typical number is Rₜₕ=150 K/W). The temperature increase can be estimated by ΔT_{bulk}=Rₜₕ*P_{diss}.

Lines 403 are indicative of the heat dissipation through bulk 408 of the device. As depicted in the figure, gain region 404 is the primary heat source and DBR grating 412 is passive. Under gain region 404, lines 403 depict a uniform region wherein lines 403 follow from the hotter gain region 404 to the cooler heat sink 490. Under DBR grating 412, lines 403 depict a more complex situation. Here, lines 403 indicate that the heat spreads into the passive and therefore cooler DBR grating 412 as well as to the heat sink 490. This may result in a temperature gradient across the DBR grating 412. DBRₐ is the location of DBR grating 412 closest to gain region 404. DBR_{b} is the location of DBR grating 412 farthest from gain region 404. From DBRₐ to DBR_{b} a temperature gradient (ΔT_{DBR}) may exist due to temperature dissipation non-uniformities. In a laser system, such as the known laser system shown, ΔT_{DBR} increases as injected current I₂ increases.

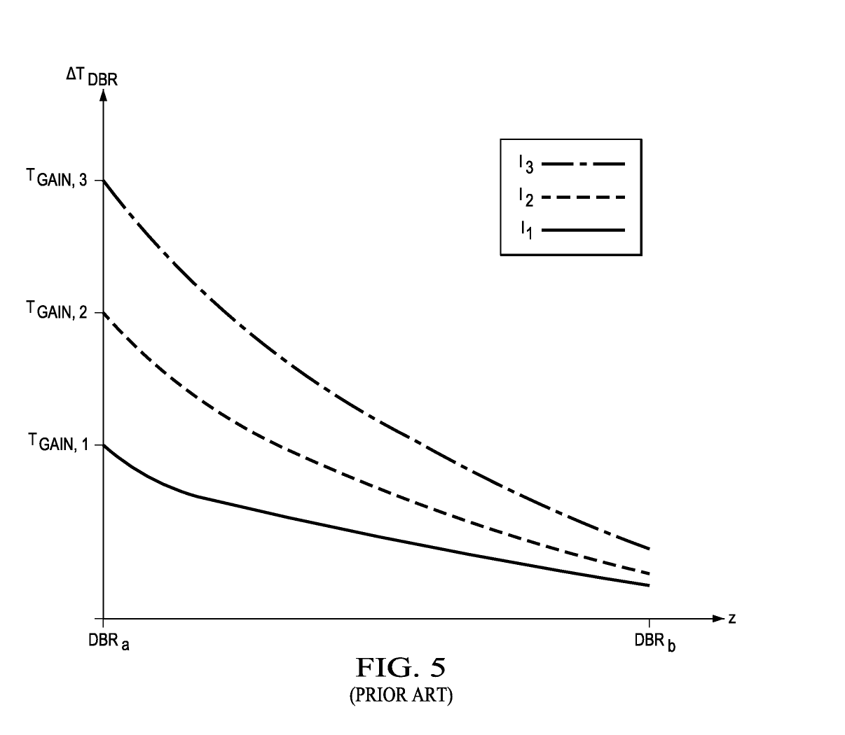

FIG. 5 is a graph indicating the ΔT_{DBR} for injected currents I₁, I₂, and I₃, where I₃ is greater than I₂ and I₂ is greater than I₁, for a known laser system. The temperature gradient across the DBR grating is related to term −Ae^{z/LT}, where A is a constant, LT was experimentally derived and may be, for example, 375 μm, and z runs the length of the DBR grating, for example from 0 μm to 400 μm. Therefore, ΔT_{DBR} for a DBR grating with increasing injected currents shows an increased temperature gradient.

The index of refraction is related to temperature as follows, η(T)=η_{(T=0)}+δη/δT*δT, where η is the index of refraction and T is the temperature. Therefore, the index of refraction across the DBR grating changes with the temperature. Since the index of refraction is related to temperature and there may be a temperature gradient across the DBR grating, the DBR grating may not function efficiently. As a light wave enters the DBR grating, some portion of it will be reflected by the first layer, while the remaining light waves will continue through to the second layer, where the process continues. The separately reflected light waves will remain in phase if the difference in the optical path length of each light wave is equal to an integer multiple of the light wavelength. Light waves that satisfy this condition constructively interfere and result in a reflected wave of significant intensity. The achieved reflectivity is determined by the number of layer pairs, such as period 305 depicted in FIG. 3, and by the refractive index contrast between the layer materials. Further, the reflection bandwidth is determined mainly by the index contrast. An increased temperature gradient then presents a problem in a DBR grating, in that the DBR grating may function most efficiently when the index of refraction across the DBR grating is uniform across each period of the DBR grating. However, when the temperature, and therefore the index of refraction, changes across the DBR grating, different wavelengths of light may be reflected dependent on the temperature, and therefore the position, in the DBR region. The Bragg condition may not be met and therefore constructive interference hindered. Thus, the laser system output may diminish. Moreover, the laser system output may comprise undesired spectral features.

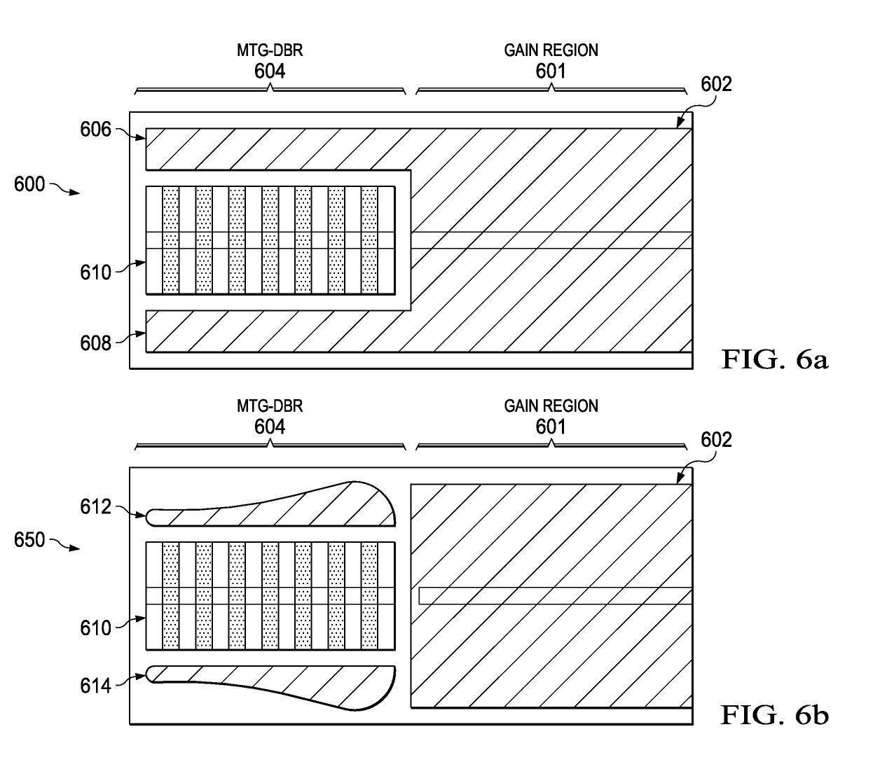

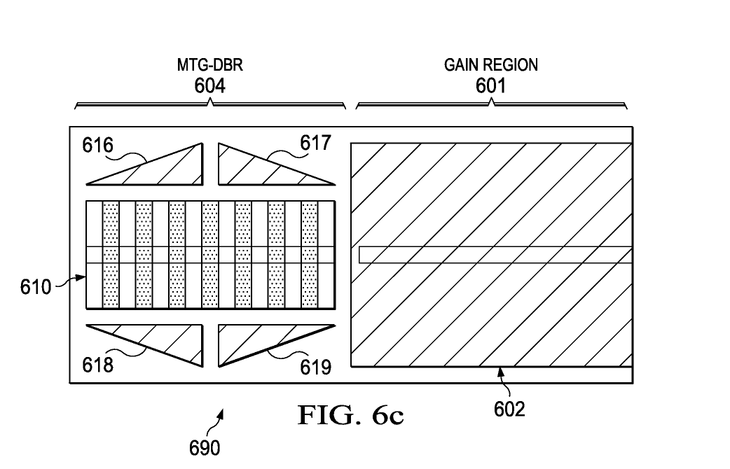

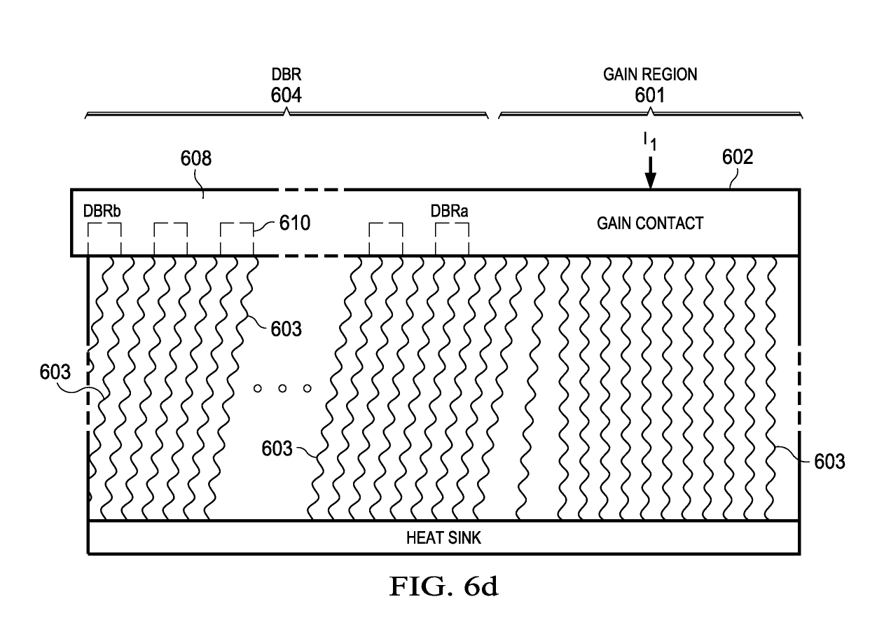

An advantage of an illustrative embodiment is that the temperature gradient across the MTG-DBR region is reduced, thus stabilizing the temperature and therefore the index of refraction across the MTG-DBR grating. FIG. 6a shows a plan view of a mitigated temperature gradient-distributed Bragg reflector (MTG-DBR), in accordance with an illustrative embodiment. FIG. 6a shows a detail view of gain region 601 and MTG-DBR region 604. In portions of improved laser system 600, gain region 601 is shown with gain contact 602. MTG-DBR region 604 is shown with heat conducting features 606 and 608 parallel to DBR grating 610. Heat conducting features 606 and 608 are shown as rectangles attached to gain contact 602.

In an illustrative embodiment, the heat-conducting features of the MTG-DBR may or may not be formed at the same time and of the same material as gain contact 602.

An example of a p-type gain contact metal, which may be used for the heat conducting features 606 and 608 is TiPtAu. NiAuGe is an example of an n-type gain contact metal, which may also be used for the heat conducting features 606 and 608. However, other conductive layers may be used within the scope of the illustrative embodiments. Further, the heat-conducting features may not be formed at the same time or at the same level as gain contact 602.

Turning to FIG. 6b, another embodiment of a portion of an improved MTG-DBR laser 650 is shown. This embodiment may include detached heat conducting features 612 and 614. While heat conducting features 612 and 614 are similarly shaped reflections in this example, the illustrative embodiments are not so limited. Further, one or more heat conducting features, such as 612 and 614, may be interconnected to a temperature regulating system such as a cooling system or a heating system. The interconnection to a cooling system or heating system may be similar to the gain contact interconnection to a current source, neither connection shown in FIG. 6b. By employing a temperature control system, the temperature gradient may be reduced to a level that allows a stable spectrum at the desired laser power.

Turning now to FIG. 6c, it can be seen that heat conducting features 616-619 may be detached from each other and gain contact region 602. Heat conducting features of varying sizes and shapes are within the scope of this invention as shown in MTG-DBR structure 690. The heat conducting features may or may not be symmetrical on either side of the MTG-DBR region.

FIG. 6d shows a cross sectional view of a portion of an MTG-DBR laser, such as shown in FIG. 6a. Gain contact 602 is shown in a layer that connects to the heat conducting feature 608. The DBR structure 610 (shown in phantom) is not covered by heat conducting feature 608, rather heat conducting feature 608 is in the foreground of the drawing. Heat lines 603 depict a more even heat dissipation across MTG-DBR region than in DBR of FIG. 4. The heat conducting features 608 and 610 (610 is not shown), may conduct heat away from MTG-DBR region near gain region heat source (DBRₐ) and direct it towards the other end of MTG-DBR region (DBR_{b}), which may have the effect of abating the temperature gradient across MTG-DBR region. The index of refraction across the MTG-DBR grating 610 may be more uniform than the index of refraction of a DBR grating operating at the same injected current level without heat conducting features. Thus, the MTG-DBR laser may output higher power light and more stable spectrums with a minimum of unwanted spectral features than a standard DBR. These heat conducting features may also be connected to other heating or cooling sources, thereby forcing the desired temperature gradient on MTG-DBR region.

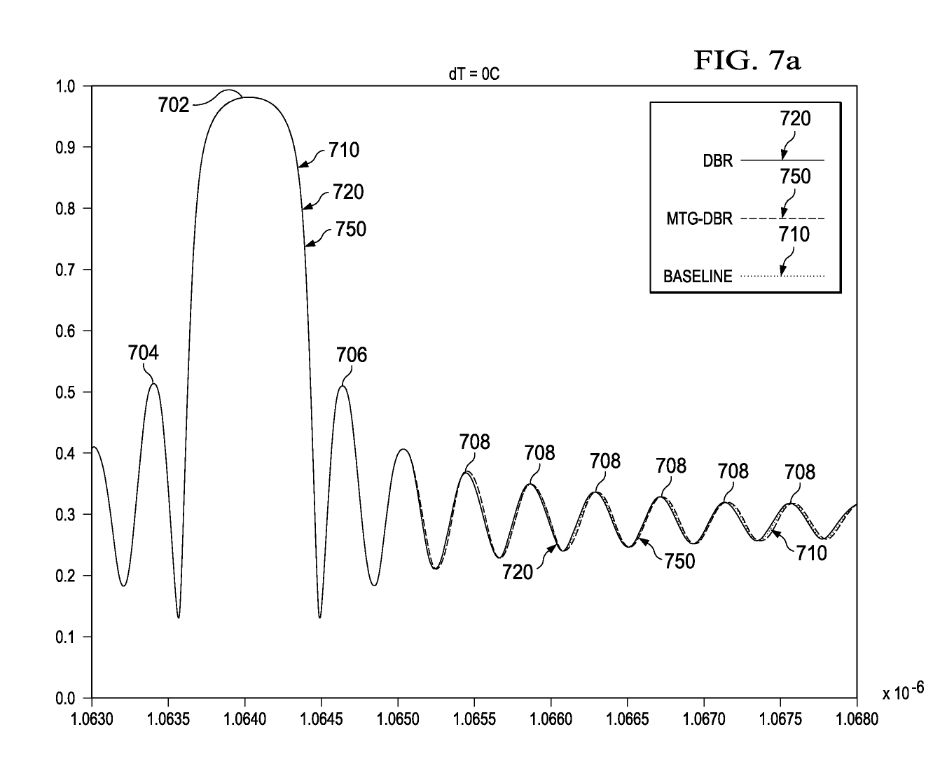

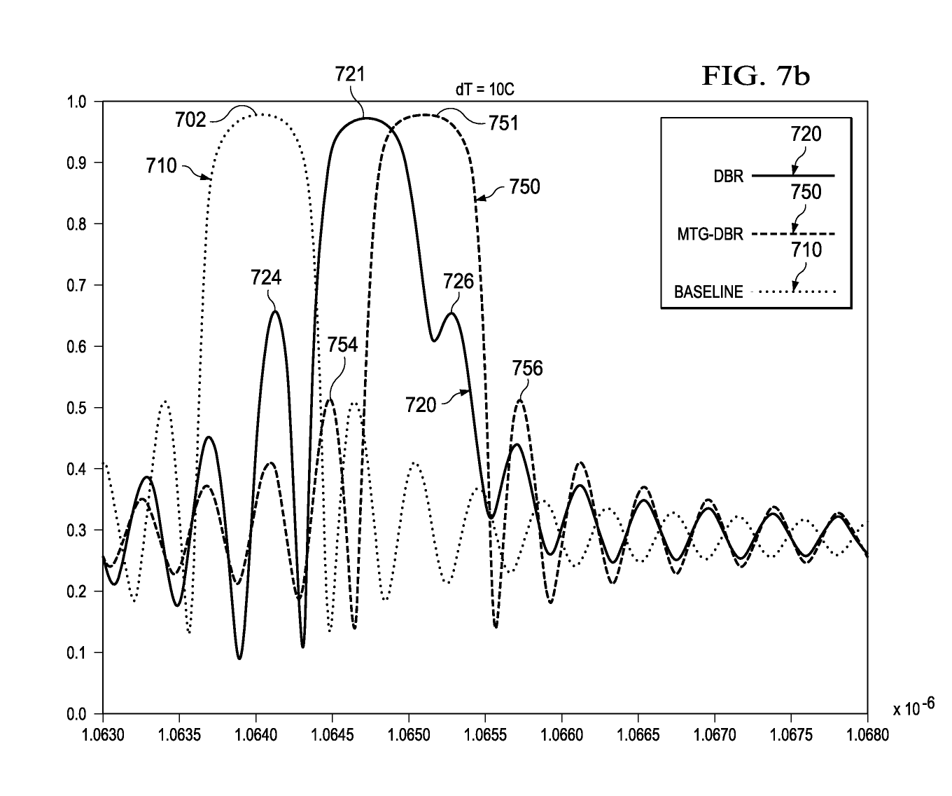

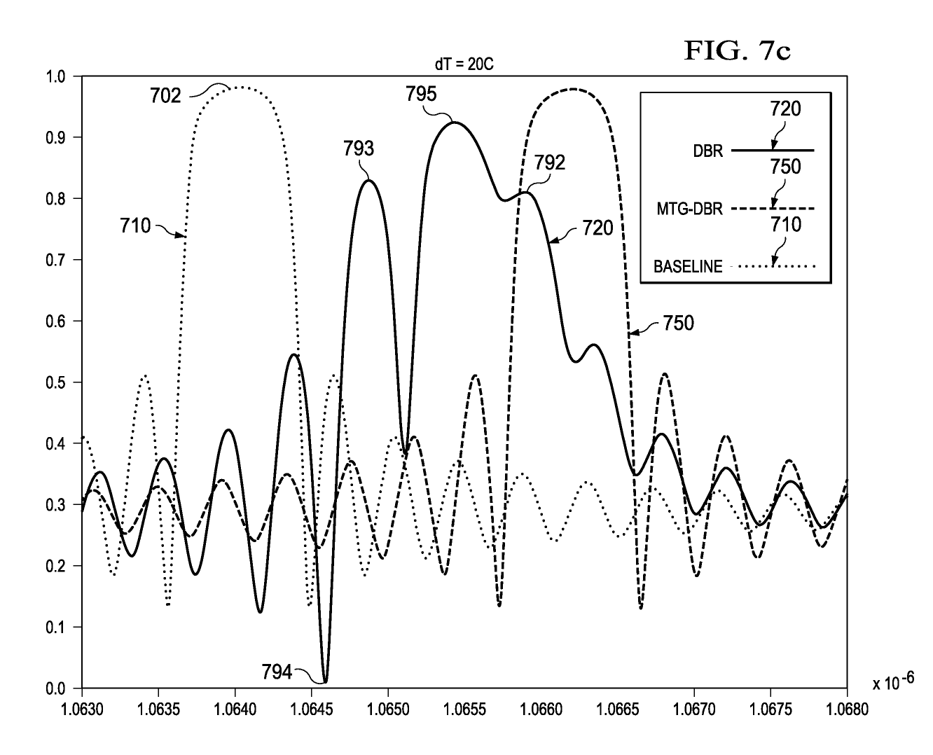

FIG. 7 shows three spectral graphs simulating three different injected currents in a laser system. Each injected current causes a temperature change (dT) across the laser device. Temperature changes (dTs) across the device are estimated for each graph. Further, each graph shows three curves, baseline curve 710, standard DBR curve 720, and MTG-DBR curve 750. The x-axis represents the wavelength of light output in microns. The y-axis is the light intensity in arbitrary units. More particularly, FIG. 7a shows a theoretical spectral graph of the laser output with no temperature gradient (dT=0 C) as a baseline of a spectral output. Theoretically, at dT=0 C, both the laser system with DBR curve 720, and the laser system with MTG-DBR 750, overlay baseline curve 710. Note that peak 702 on baseline curve 710 is primarily between 1.0635 μm and 1.0645 μm. There are well-defined side features 704 and 706 on both sides of peak 702, with further small peaks 708 diminishing in intensity.

FIG. 7b shows the same three spectral curves as shown in FIG. 7a, but at dT=10 C. Baseline curve 710, with peak 702, represents the output of a DBR laser system with a theoretical 0 C dT, for reference. DBR curve 720 represents the output of a DBR laser system at injected current I₂, and MTG-DBR curve 750 represents the output of a MTG-DBR laser system at injected current I₂. DBR curve 720 comprises DBR peak 721, which is offset and thinner than peak 702 of baseline curve 710. Moreover, DBR curve 720 shows spectral features, such as features 724 and 726, which are undesired. In contrast, however, MTG-DBR curve 750 comprises peak 751 and well-defined side features 754 and 756. MTG-DBR curve 750 is similar to baseline curve 710, but offset to between 1.0647 μm and 1.0657 μm.

FIG. 7c shows, at dT=20 C, the same three spectral curves as shown in FIG. 7a and FIG. 7b. Baseline curve 710, DBR curve 720, and MTG-DBR curve 750 are as FIG. 7b, except at an injected current I₃. Note that DBR curve 720 has tended toward disorganization, with many undesired spectral features, such as spectral features 792, 793, and 794. DBR peak 795 is less defined and thinner than baseline peak 702, and less defined and thinner than DBR curve 720 at current=I₂, in FIG. 7b. In contrast, MTG-DBR curve 750 is similar to baseline curve 710 except that MTG-DBR is offset to between 1.06555 and 1.06565 μm.

As can be seen from the spectral graphs, the improved laser system with an MTG-DBR has the advantage of producing a well-defined spectrum at higher injected currents than does the DBR.

Advantages of embodiments include providing a method, structure, and system wherein the DBR reflecting techniques are optimized for a higher dT, therefore a higher injected current, and a higher power output. Other advantages include an improved spectral output which may have fewer undesired spectral features.

Although the illustrative embodiment and its advantages have been described in detail, it should be understood that various changes, substitutions, and alterations can be made herein without departing from the spirit and scope of the invention as defined by the appended claims. For example, many of the features and functions discussed above can be implemented in software, hardware, or firmware, or a combination thereof. As another example, it will be readily understood by those skilled in the art that gain regions and outcouplers may be varied while remaining within the scope of the present invention.

Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A semiconductor laser system comprising:
a gain region;
a gain contact coupled to the gain region;
a distributed Bragg reflector having a near side and a far side with respect to the gain region, wherein the distributed Bragg reflector reflects a resonant frequency of light back into the gain region;
a heat conducting structure, wherein the heat conducting structure is positioned to transfer heat in a direction from the near side to the far side of the distributed Bragg reflector and wherein the heat conducting structure is electrically isolated from any signal source; and
an outcoupler, wherein the outcoupler is positioned to outcouple the resonant frequency of light from the semiconductor laser system.

2. The semiconductor laser system of claim 1, wherein the heat conducting structure is formed of a same material as the gain contact.

3. The semiconductor laser system of claim 1, wherein the heat conducting structure is attached to the gain contact.

4. The semiconductor laser system of claim 1, wherein the heat conducting structure comprises a plurality of detached heat conducting structures.

5. The semiconductor laser system of claim 1, wherein the heat conducting structure is interconnected to a temperature control system.

6. A structure comprising:
a gain contact proximate to a gain region;
a distributed Bragg reflector having a near side and a far side with respect to the gain region, wherein the distributed Bragg reflector is employed to reflect resonant frequencies of light; and
a heat conductor on opposing sides of the distributed Bragg reflector, wherein the heat conductor varies in size along the distributed Bragg reflector such that the heat conductor is small at the near side and larger at the far side.

7. The structure of claim 6, wherein the heat conductors are formed of the same material as the gain contact.

8. The structure of claim 6, wherein the heat conductors are attached to the gain contact.

9. The structure of claim 6, wherein the heat conductors are comprised of a plurality of detached heat conducting structures.

10. The structure of claim 6, wherein the heat conductors are interconnected to a temperature control system.

11. A method of providing light from a laser system, the method comprising:
providing an injected current through a gain contact into a gain region of the laser system;
providing a mitigated temperature gradient-distributed Bragg reflector (MTG-DBR) to abate a temperature gradient across a reflecting structure within the laser system, the mitigated temperature gradient-distributed Bragg reflector (MTG-DBR) being not directly electrically connected to an electrical source; and
outputting light from the laser system.

12. The method of claim 11 further comprising forming in the MTG-DBR, a heat conducting feature of a same material and at a same time as a gain contact.

13. The method of claim 11 further comprising attaching a heat conducting feature in the MTG-DBR to the gain contact.

14. The method of claim 11 further comprising forming a plurality of heat conducting features in the MTG-DBR detached from the gain contact.

15. The method of claim 11 further comprising connecting a heat-conducting feature in the MTG-DBR to a temperature control system.

16. A semiconductor laser system comprising:
a gain region;
a gain contact coupled to the gain region;
a distributed Bragg reflector having a near side and a far side with respect to the gain region, wherein the distributed Bragg reflector reflects a resonant frequency of light back into the gain region;
a heat conducting structure, wherein the heat conducting structure is positioned to transfer heat in a direction from the near side to the far side of the distributed Bragg reflector and wherein the heat conducting structure is directly attached to the gain contact; and
an outcoupler, wherein the outcoupler is positioned to outcouple the resonant frequency of light from the semiconductor laser system.

17. The semiconductor laser system of claim 16, wherein the heat conducting structure is formed of a same material as the gain contact.

18. The semiconductor laser system of claim 16, wherein the heat conducting structure comprises a plurality of detached heat conducting structures.

19. The semiconductor laser system of claim 16, wherein the heat conducting structure is interconnected to a temperature control system.

20. The structure of claim 6, wherein the detached heat conducting structures are placed on a top surface of the distributed Bragg reflector, wherein the detached heat conducting structures do not overlie a distributed Bragg reflector grating.
